(19) United States
(12) Patent Application Publication
(10) Pub. No.: US 2020/0410917 A1
(43) Pub. Date: Dec. 31, 2020

(54) Electronic Display Device And Electronic Display Method

(71) Applicant: Progress Technologies, Inc., Koto-ku, Tokyo (JP)

(72) Inventors: Atsushi Yamada, Tokyo (JP); Shuhei Chiba, Tokyo (JP); Yuta Kuboyama, Tokyo (JP)

(21) Appl. No.: 16/975,576

(22) PCT Filed: Feb. 7, 2019
(86) PCT No.: PCT/JP2019/004335

§ 371 Date: Aug. 25, 2020

(30) Foreign Application Priority Data
Feb. 26, 2018 (JP) 2018-032583

(51) Int. Cl. G09G 3/20; G06F 3/14

(52) U.S. Cl. CPC G09G 3/20; G09G 2340/0464; G09G 2360/04; G06F 3/1431

(57) ABSTRACT

An electronic display device includes a plurality of displays, a sub-memory, and a control circuit. The displays display content. The sub-memory temporarily stores image information of images to be displayed on the displays. The control circuit controls presentation on the displays. Further, upon updating images displayed on the displays, the control circuit rewrites the image information stored in the sub-memory in advance into the image information of the image currently displayed on the display to be updated.

### TECHNICAL FIELD

Embodiments of the present invention relate to an electronic display device and an electronic display method.

### BACKGROUND

Electronic papers (electronic display devices) that display content as electronic information have recently been in widespread use. In addition, various kinds of content are provided, such as writing including novels and essays and pictures including cartoons. Moreover, there are light and small devices, such as an e-book device, which are excellent in portability.

On the other hand, in such an electronic display device, due to the display characteristics, when an image is updated, the previously displayed image remains as an afterimage (ghost). Here, FIG. 10 is an explanatory diagram for explaining a state where a ghost occurs.

In the explanatory diagram of FIG. 10, two areas surrounded by square frames are shown on the left and right, and graphics are shown in the respective areas. In other words, these frames represent “displays”, and the graphics shown in the areas inside the frames correspond to “images” displayed on the displays. A “face” is shown on the display on the left side of FIG. 10, while a “cat” is shown on the display on the right side. A right-pointing arrow is shown between the left display and the right display. This represents a state where the screen of the left display is updated and shifted to the screen of the right display.

As can be seen here from the right display, which is the updated display, the “face” displayed on the left display is displayed faintly behind the “cat” displayed. The “face” shown on the updated display is the ghost.

As described above, the ghost is displayed faintly behind the updated image in the area where only the updated image is supposed to be displayed. Therefore, the visibility of the updated image is reduced. As a method for reducing a ghost, for example, a method is employed wherein the displayed image is temporarily inverted and then the updated image is displayed on the display.

FIG. 11 is an explanatory diagram for explaining ghost reduction processing. FIG. 11 shows the two displays shown in FIG. 10 that display “face” and “cat”, respectively. Also, between these two displays, there is a display that shows a state where the “face” is inverted. Therefore, FIG. 11 shows three displays in total.

There are also right-pointing arrows shown between the “face” display, the “inverted face” display, and the “cat” display. Therefore, in FIG. 11, the screen is updated in order from the “face” display to the “inverted face” display to the “cat” display.

Furthermore, square frames are shown in the upper left of the “face” display and the “cat” display. These frames each represent a memory circuit that stores image information. For example, image information of “face” is stored in the memory circuit shown in the upper left of the “face” display. The state where the image information is stored in the memory circuit is indicated by the “face” drawn in the balloon shown in the upper right of the memory circuit.

Next, a specific ghost reduction process will be described. It is assumed that the image of “face” is currently displayed on the display. In this case, the memory circuit stores image information regarding the “face” image, and this state is shown in the left part of FIG. 11. It is attempted here to display the image of “cat” on the display. In order to display the image of “cat” on the display, it is required to store the image information of “cat” in the memory circuit.

Therefore, in order to display the image of “cat” on the display, along with the process of storing the image information of “cat” in the memory circuit, the image information of “face” originally stored in the memory circuit is used to invert the face image displayed on the display. This is the state of the “inverted face” display shown in the middle of the three displays shown in FIG. 11.

By performing the inversion process once and then updating the image as described above, the “face” image is not displayed, unlike the case shown in FIG. 10, behind the “cat” image displayed on the display as shown in the right display. That is, the ghost can be reduced. When the “cat” image is displayed on the display as described above, the image information of “cat” is stored in the memory circuit.

Such a ghost reduction process is performed as follows in an actual electronic display device, for example. FIGS. 12 and 13 are schematic diagrams showing the flow of processing when the ghost reduction process is performed in an e-book device.

FIG. 12 shows, in particular, a case where only one control circuit that controls two displays is provided for the two displays. That is, one control circuit handles updating of the two displays. On the other hand, FIG. 13 shows a case where one control circuit is provided for each of the two displays. That is, each display is provided with one control circuit that performs update processing, and the control circuit and the display have a one-to-one relationship.

As in FIG. 11, a memory circuit is shown above the display of the e-book device. Because the memory circuit is provided for each control circuit, one memory circuit is shown in FIG. 12 and two memory circuits are shown in FIG. 13 depending on the number of control circuits.

Note that FIGS. 12 and 13 both show the state where the e-book device is open. The e-book device in a spread state has one display on each side. An operator of the e-book device reads from the right-hand page to the left-hand page, for example. It is assumed here that the right display of the two displays is the “first display” and the left display is the “second display”.

Note that, here, the following description is given on the assumption that the operator of the e-book device starts reading from the right-hand page to the left-hand page. That is, the order of image update processing for the display described below is the order of the right display and then the left display. However, depending on the e-book device, the operator of the e-book device may be able to read from the left-hand page to the right-hand page. In this case, the order of the above-mentioned image update processing is reversed, resulting in the order of the left display and then the right display.

At the start of the ghost reduction processing, “A” is displayed on the first display and “B” is displayed on the second display. It is assumed that, at the end of the ghost reduction processing, “C” is displayed on the first display and “D” is displayed on the second display. That is, the display content on the first display is updated from “A” to “C”, and the display content on the second display is updated from “B” to “D”.

FIGS. 12 and 13 show how the presentation on the display of the e-book device is actually updated (screen transition) in the upper part. On the other hand, the lower part shows the ghost reduction processing performed during updating of the presentation on the display shown in the upper part.

The display that is the update target is indicated by the broken line, while the display that is not the update target is indicated by the solid line. Also, the presentation on each display is updated as indicated by the large solid arrow, and the actual ghost reduction processing is executed in the order indicated by the broken arrow.

First, the ghost reduction processing in the e-book device is described with reference to FIG. 12. As described above, in the e-book device shown in FIG. 12, only one control circuit and one memory circuit are provided, which are used to update two displays.

In the e-book device shown on the upper left side of FIG. 12, “A” is currently displayed on the first display and “B” is currently displayed on the second display. Also, the image information of “B” is stored in the memory device. As described above, because the operator reads in the order of the first display and then the second display, the image update is also executed in the order of the first display and then the second display. Therefore, in the state shown in FIG. 12, “A” is displayed on the first display, and then “B” is displayed on the second display. Therefore, the memory circuit stores the image information of “B” displayed on the second display.

Here, processing of updating the image of “A” displayed on the first display to the image of “C” is started. Therefore, the image information of “C” is stored in the memory circuit.

Upon storing the image information of “C” in the memory circuit, the e-book device first uses the image information of “B” originally stored in the memory circuit to perform inversion processing and display processing on the first display that displays the image of “A”. This state is shown in the diagram of the e-book device shown on the lower left side.

In the e-book device shown on the lower left side, the presentation on the first display to be updated is inverted from “A” and updated to “B”. Then, because new image information of “C” is stored in the memory circuit, “C” is subsequently displayed on the first display. Thus, the image update on the first display is completed, at which point “C” is displayed on the first display and “B” remains displayed on the second display. This state appears in the e-book device shown in the middle of the upper part of FIG. 12.

However, the inverted image “A” is displayed as a ghost behind the updated “C” image shown in the first display. This is because the image information stored in the memory circuit (here, the image information of “B”) is different from the image “A” actually displayed on the first display. Therefore, the image “A” that is originally displayed on the first display is not completely deleted and remains as a ghost.

Next, update processing is performed on the image displayed on the second display. In the e-book device shown in the upper middle of FIG. 12, the second display keeps displaying the image “B” that is not updated thus far. Here, the memory device stores the image information of “C” displayed on the first display. This memory device stores image information on an image “D” to be displayed as the second display is updated.

The e-book device recognizes that the image update processing is started by storing the image information of “D” in the memory circuit. “is stored in the memory circuit, the e-book device first uses the image information of “C” originally stored in the memory circuit to perform inversion processing and display processing on the second display that displays the image “B”. This state is shown in the diagram of the e-book device shown on the lower right side.

In the e-book device shown on the lower right side, the presentation on the second display to be updated is inverted from “B” and updated to “C”. Then, because new image information of “D” is stored in the memory circuit, “D” is subsequently displayed on the second display. Thus, the image update on the second display is completed. At this point, “C” is displayed on the first display and “D” is newly displayed on the second display. This state appears in the e-book device shown in the upper right part of FIG. 12.

However, again, in the second display, as in the update processing of the first display, inversion processing and display processing are executed on the image actually displayed on the second display (here, the image “B”) using the image information (here, the image information of “C”) stored in the memory circuit different from the image information on the image. Therefore, the image “B” originally displayed on the second display is displayed as a ghost behind the updated image “D” displayed on the second display.

Next, the ghost reduction processing in the e-book device is described with reference to FIG. 13. As described above, the e-book device shown in FIG. 13 is provided with a control circuit and a memory circuit for each of the two displays.

First, description is given of the flow of updating the image “A” displayed on the first display to the image “C”. The memory circuit provided for the first display stores the image information of “A” currently displayed on the first display. In this state, the image information of “C” displayed on the updated first display is stored in this memory circuit.

The control circuit that controls the first display performs inversion processing and display processing based on the image information of “A” stored in the memory circuit. This state is shown in the e-book device shown on the lower left part of FIG. 13. Then, based on the image information of “C” newly stored in the memory circuit, the image “C” is further displayed on the first display (see the e-book device shown in the upper middle of FIG. 13).

Next, processing of updating the image “B” displayed on the second display to the image “D” is performed. The memory circuit provided for the second display stores the image information of “B” currently displayed on the second display. In this state, the image information of “D” displayed on the updated second display is stored in this memory circuit.

The control circuit that controls the second display performs inversion processing and display processing based on the image information of “B” stored in the memory circuit. This state is shown in the e-book device shown in the lower right part of FIG. 13. Then, based on the image information of “D” newly stored in the memory circuit, the image “D” is further displayed on the second display (see the e-book device shown in the upper right of FIG. 13).

### BRIEF SUMMARY

However, the above-described ghost reduction processing methods may each have the following adverse effects.

First, in the case where the two displays are controlled using one control circuit and one memory circuit, which is described with reference to FIG. 12, it is highly likely that a ghost occurs upon updating the image on the display. This is because the ghost reduction processing is performed using one memory circuit.

More specifically, upon update processing, the inversion processing and the display processing are always performed on the display to be updated. As described above, the inversion processing and the display processing are performed in order to reduce the possibility of a ghost occurring due to the use of the same image information as the image information of the image displayed. However, when only one memory circuit is provided, as described with reference to FIG. 12, the image information used for the inversion processing and the display processing is different from the image information of the image displayed at that point. Therefore, the ghost is not sufficiently reduced.

On the other hand, when one control circuit and one memory circuit are provided for each of the two displays as described with reference to FIG. 13, no such adverse effect occurs as in the case where only one memory circuit is provided as described above. This is because the image information of the image actually displayed on the display matches the image information used for the inversion processing and the display processing.

On the other hand, when control circuits and memory circuits are provided for the number of displays, the cost of the electronic display device increases. In addition, wiring in the entire device becomes complicated and power consumption is also increased. Furthermore, the weight of the entire device is increased, which could make it difficult to reduce the device size.

The present invention has been made to solve the above problems, and it is an object of the present invention to provide an electronic display device and an electronic display method capable of sufficiently reducing the occurrence of ghost even with the use of one control circuit and one memory circuit and also capable of maintaining an operation speed, upon update processing on images on a plurality of displays.

An electronic display device according to an embodiment includes a plurality of displays, a sub-memory, and a control circuit. The displays each display content. The sub-memory temporarily stores image information of an image to be displayed on the display. The control circuit controls the presentation on the display. Upon updating the images to be displayed on the displays, the control circuit rewrites in advance the image information stored in the sub-memory into the image information of the image currently displayed on the display to be updated.

An electronic display method according to the embodiment includes the of, upon updating an image displayed on a display included in an electronic display device, inverting the image based on image information stored in a sub-memory, rewriting the image information stored in the sub-memory into image information of an image currently displayed on the display to be updated, and storing, in the sub-memory, and displaying the rewritten image information of the image currently displayed on the display to be updated, further rewriting the rewritten image information of the image currently displayed on the display to be updated into image information of an image to be displayed on the display after updating, and updating the presentation on the display with a new image based on the image information of the image displayed on the display after the updating.

The present invention can provide an electronic display device and an electronic display method capable of sufficiently reducing the occurrence of ghost even with the use of one control circuit and one memory circuit and also capable of maintaining an operation speed, upon update processing on images on a plurality of displays.

### BRIEF DESCRIPTION OF DRAWINGS

FIG. 1 is an external perspective view showing a configuration example of an e-book device according to an embodiment in an open state.

FIG. 2 is an external perspective view showing a configuration example of the e-book device according to the embodiment of FIG. 1 in a closed state.

FIG. 3 is a functional block diagram functionally showing the entire configuration of the e-book device according to the embodiment of FIG. 1.

FIG. 4 is a flowchart showing a flow of ghost reduction processing executed in the e-book device according to the embodiment of FIG. 1.

FIG. 5 is a flowchart showing the flow of the ghost reduction processing executed in the e-book device according to the embodiment of FIG. 1.

FIG. 6 is a flowchart showing the flow of the ghost reduction processing executed in the e-book device according to the embodiment of FIG. 1.

FIG. 7 is a flowchart showing the flow of the ghost reduction processing executed in the e-book device according to the embodiment of FIG. 1.

FIG. 8 is a flowchart showing a flow of image update processing executed in the e-book device according to the embodiment of FIG. 1.

FIG. 9 is a flowchart showing the flow of the image update processing executed in the e-book device according to the embodiment of FIG. 1.

FIG. 10 is an explanatory diagram for explaining a state where a ghost occurs.

FIG. 11 is an explanatory diagram for explaining ghost reduction processing.

FIG. 12 is a schematic diagram showing a processing flow when ghost reduction processing is performed in a conventional e-book device.

FIG. 13 is a schematic diagram showing a processing flow when ghost reduction processing is performed in a conventional e-book device.

### DETAILED DESCRIPTION

Hereinafter, embodiments will be described in detail with reference to the drawings. In the following description, an e-book device will be described as an example among various types of electronic display devices.

Configuration of e-Book Device

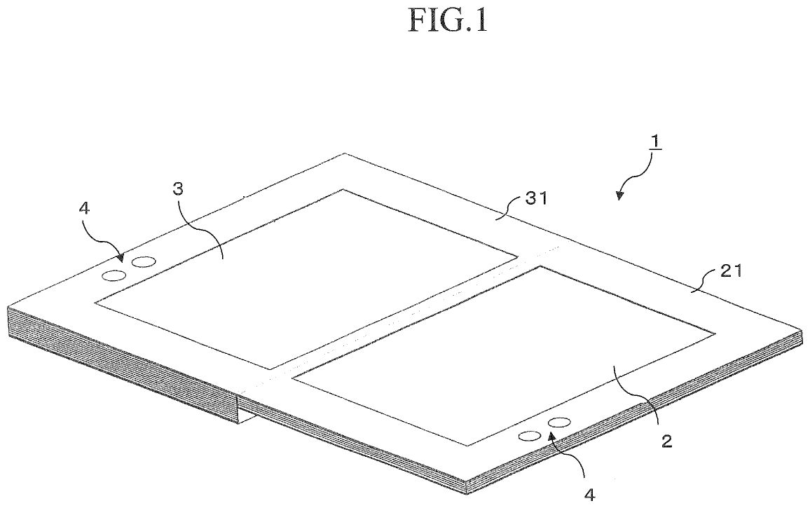

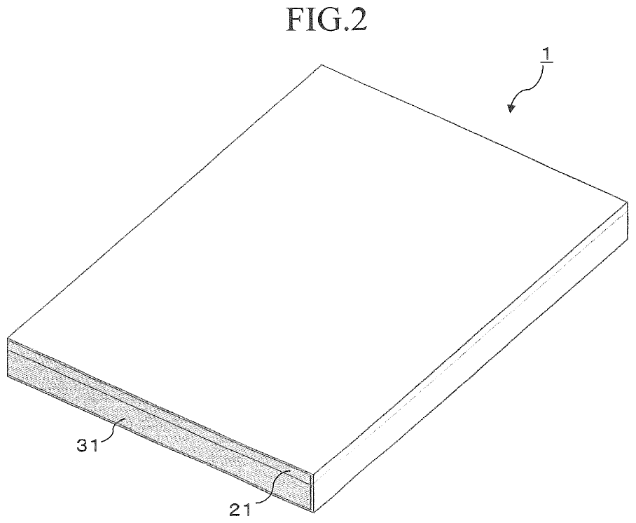

FIG. 1 is an external perspective view showing a configuration example of an e-book device 1 according to an embodiment in an open state. FIG. 2 is an external perspective view showing a configuration example of the e-book device 1 according to the embodiment in a closed state.

The e-book device 1 is a kind of electronic display device, which displays various kinds of content configured as electronic information on a display so that an operator can see (read) characters and pictures displayed on the display.

The e-book device 1 according to an embodiment of the present invention includes two displays on the left and right, for example, as shown in FIG. 1. It is assumed, in this embodiment, that the display shown on the right side in FIG. 1 of the two displays is a first display 2 and the display shown on the left side is a second display 3.

The e-book device 1 includes an approximately rectangular parallelepiped right-hand housing 21 in which the first display 2 is disposed and an approximately rectangular parallelepiped left-hand housing 31 in which the second display 3 is disposed. In this embodiment, the first and second displays 2 and 3 have their display surfaces formed in a rectangular shape. However, the shape of the housings of the e-book device 1 or the shape of the display surfaces of the first and second displays 2 and 3 are not limited to the rectangular shape. Therefore, any other shapes may be adopted.

As can be seen from the e-book device 1 in FIG. 1, the e-book device 1 can also be configured in a state where the first display 2 in the right-hand housing 21 and the second display 3 in the left-hand housing 31 have their display surfaces arranged side by side. This state imitates the shape of an open book, which is assumed when the e-book device 1 is used.

On the other hand, as shown in FIG. 2, when the display surfaces of the first display 2 in the right-hand housing 21 and the second display 3 in the left-hand housing 31 are aligned, the right-hand housing 21 and the left-hand housing 31 are stacked. This state imitates the shape of a closed book, which is assumed when the e-book device 1 is stored.

Note that, as shown in FIG. 1, the right-hand housing 21 and the left-hand housing 31 are spreadably connected to each other. The e-book device 1 is configured to be switched between the open state and the closed state by changing the angle formed by the surfaces of the right-hand housing 21 and the left-hand housing 31 about the connecting portion therebetween.

Referring back to FIG. 1, in the e-book device 1, the right-hand housing 21 and the left-hand housing 31 are provided with input units 4, respectively. Although the input unit 4 has a button shape in FIG. 1, any configuration, shape, and the like may be adopted for the input unit 4. Furthermore, the location to provide the input unit 4 and the number thereof can be arbitrarily set.

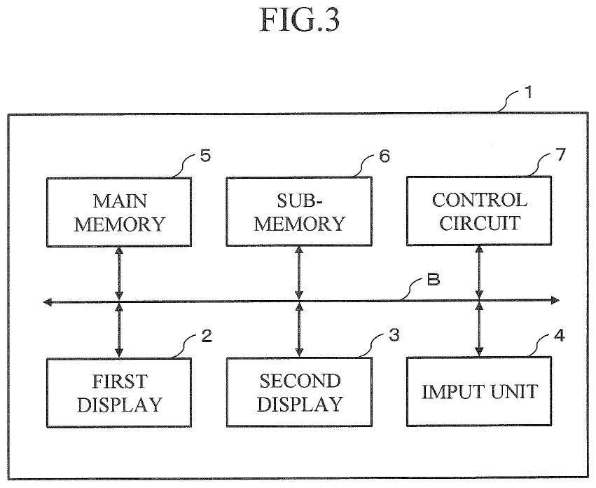

FIG. 3 is a functional block diagram functionally showing the entire configuration of the e-book device 1 according to the embodiment. The e-book device 1 includes the first display 2, the second display 3, the input unit 4, a main memory 5, a sub-memory 6, and a control circuit 7. These components are connected by a bus B so that signals can be exchanged.

The first and second displays 2 and 3 display content under the control of the control circuit 7 to be described later. The first and second displays 2 and 3 are displays having a configuration that can be adopted as the e-book device 1, such as an electrophoresis system, for example.

In the embodiment described above, two displays, the first display 2 and the second display 3, are provided. However, the number of displays is not limited to two, but may be two or more. Moreover, how to display the content on the first display 2 and the second display 3 can also be arbitrarily set. For example, it is possible to set a display area of one display as one display area, or to display the content by dividing the display area into two or more display areas.

The input unit 4 is used by an operator who operates the e-book device 1 to perform various operations such as turning on the power or turning a page forward and backward. When a plurality of contents are stored in the e-book device 1, the input unit 4 can also be used to switch the display of these plurality of contents.

The main memory 5 includes, for example, a semiconductor or a magnetic disk. The main memory 5 stores content that can be displayed on the e-book device 1. The number of contents stored in the main memory 5 is determined by the capacity of the main memory 5. The main memory 5 may also store various programs and the like used in the e-book device 1.

The sub-memory 6 stores information required for screen update processing in the e-book device 1. More specifically, the sub-memory 6 temporarily stores image information of images to be displayed on the first and second displays 2 and 3. Note that the reason for temporarily storing the image information here is that the image information in the sub-memory 6 is frequently rewritten during the screen update processing.

Note that the e-book device 1 according to FIG. 1 adopts the configuration in which the main memory 5 and the sub-memory 6 are provided as devices for storing information. However, instead of such a configuration, the main memory 5 may have the function of the sub-memory 6, for example. Alternatively, a storage device may be provided as appropriate depending on the type of information to be stored.

Furthermore, as for the main memory 5 that stores content, in particular, an external storage device such as an SD card may be used, for example, instead of providing the main memory 5 in the e-book device 1 as in the illustrated embodiment.

The control circuit 7 integrally controls the respective components of the e-book device 1. For example, images are displayed on the first and second displays 2 and 3 by the operator turning on the power. The control circuit 7 also performs update processing on such images as needed while performing ghost reduction processing.

Although not included in the configuration of the e-book device 1 shown in FIG. 3, a communication control circuit may be provided, for example. Allowing access to an external communication network such as the Internet, for example, through the communication control circuit also enables processing such as downloading content, for example.

Note that the ghost reduction processing and the image update processing by the control circuit 7, for example, can also be implemented by causing a processor to execute various programs, such as a ghost reduction processing program, stored in a predetermined memory, storage circuit, or the like. Here, the term “processor” in the present specification means, for example, a dedicated or general-purpose central processing unit (CPU) arithmetic circuit (circuitry), or a circuit such as an application specific integrated circuit (ASIC) and a programmable logic device (for example, simple programmable logic device (SPLD), a complex programmable logic device (CPLD), and a field programmable gate array (FPGA)).

The processor realizes the functions by reading and executing a program stored, for example, in the main memory 5 or directly incorporated in the circuit of the processor. A memory circuit that stores the program may be provided individually for each processor, or may adopt the configuration of the main memory 5 shown in FIG. 3, for example. For the configuration of the memory circuit, a storage device is applied such as a general random access memory (RAM) such as a semiconductor or a magnetic disk, a hard disc drive (HDD) or an SD card.

Operations

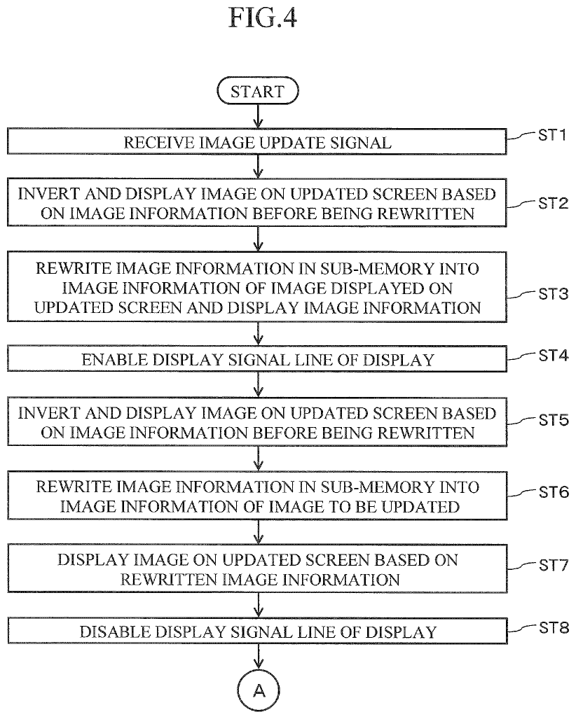

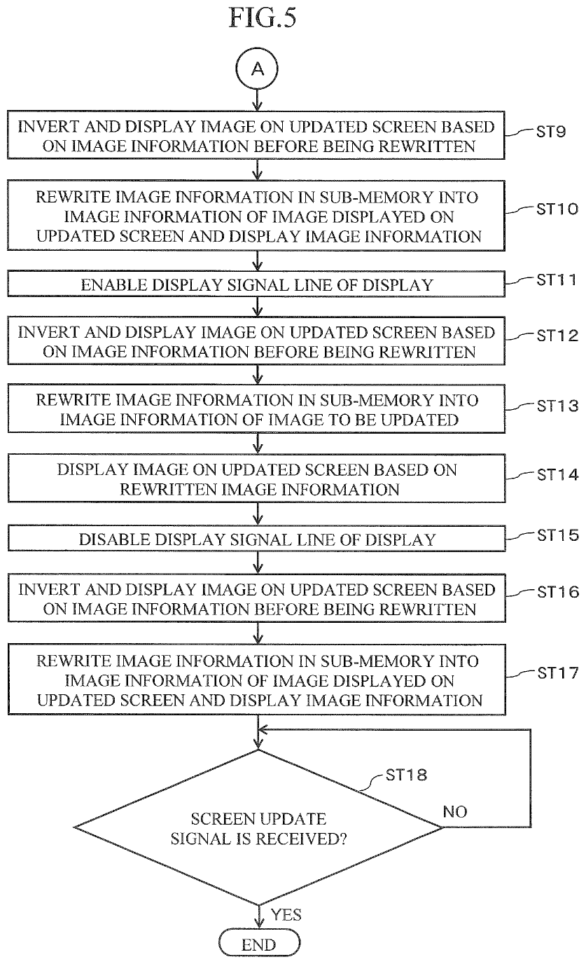

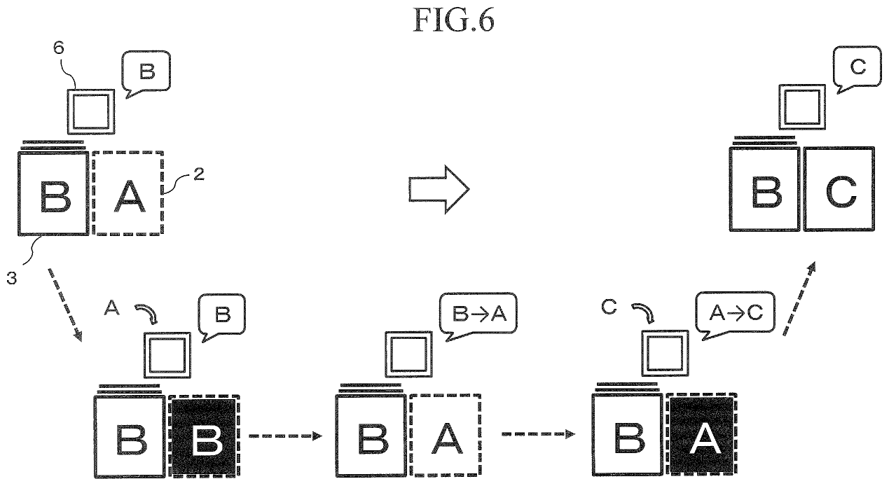

Next, with reference to FIGS. 4 to 9, the image update processing and ghost reduction processing in the first and second displays 2 and 3 will be described below. Here, FIGS. 4 and 5 are flowcharts each showing the flow of the ghost reduction processing executed in the e-book device according to the embodiment. FIGS. 6 to 9 are explanatory diagrams each showing the flow of the ghost reduction processing executed in the e-book device according to the embodiment.

FIGS. 6 to 9 each shows the open state of the e-book device 1. As shown in FIG. 1, the e-book device 1 in the spread state is provided with one display on each side. The display on the right side of the two displays is the first display 2 and the display on the left side is the second display 3.

As described above, the operator of the e-book device 1 can read from the right-hand page to the left-hand page or from the left-hand page to the right-hand page. Here, description is given of the case where the operator reads from the right-hand page to the left-hand page, as an example. Therefore, in the following description, it is assumed that the image update processing is performed in the order of the first display 2 and then the second display 3.

At the start of image update processing and ghost reduction processing, “A” is displayed on the first display 2 and “B” is displayed on the second display 3. On the other hand, at the end of the image update processing and ghost reduction processing, “C” is displayed on the first display 2 and “D” is displayed on the second display 3.

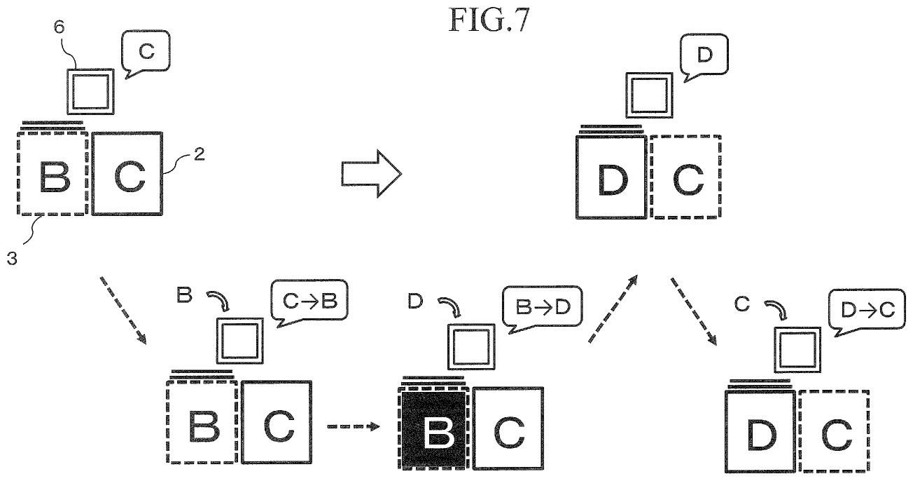

More specifically, as shown in the flow of the image update processing in the upper part of FIGS. 6 and 7, the display content on the first display 2 is updated from “A” to “C” and the display content on the second display 3 is updated from “B” to “D”.

The upper part of FIGS. 6 to 9 show how the presentation on the displays of the e-book device is actually updated (screen transition). On the other hand, the lower part shows the ghost reduction processing performed during the update of the presentation on the displays shown in the upper part.

The display to be subjected to the update processing is indicated by the broken line, while the display not to be subjected to the update processing is indicated by the solid line. Moreover, the presentation on each display is updated as indicated by the large solid arrow, and the actual ghost reduction processing is executed in the order indicated by the broken arrow.

The sub-memory 6 is shown above the displays of the e-book device 1 shown in FIGS. 6 to 9. In the e-book device 1 shown, only one sub-memory 6 is provided as described above. Here, the sub-memory 6 and the control circuit 7 are used to update the two displays, the first display 2 and the second display 3.

In the explanatory diagram of FIG. 6, the e-book device 1 shown in the upper left represents the e-book device 1 at the start of the image update processing and the ghost reduction processing. Therefore, as described above, the image “A” is displayed on the first display 2 and the image “B” is displayed on the second display 3. The sub-memory 6 stores image information when the screen of the second display 3 is updated, that is, image information on the image “B”. This is indicated by the letter “B” displayed in the balloon in FIG. 6.

In this state, the image update processing and the ghost reduction processing are started. The control circuit 7 receives an image update signal transmitted by the operator operating the input unit 4 (ST1 in FIG. 4), for example. The control circuit 7 starts the ghost reduction processing upon receipt of the image update signal as a trigger.

As described above, because the image update processing is performed in the order of the first display 2 and then the second display 3, the ghost reduction processing is first executed on the first display 2. The ghost reduction processing includes, as described below, two processes broadly divided as image inversion processing and display processing of an image inverted by the inversion processing (hereinafter referred to as “inversion display processing” as needed) and image information rewrite processing in the sub-memory 6 and display processing based on the rewritten image information based on the rewrite processing.

First, the control circuit 7 performs the inversion display processing based on the image information before being rewritten in the first display 2 (ST2). More specifically, the sub-memory 6 originally stores image information of the image “B”. Then, the control circuit 7 inverts the image on the first display 2 based on the image information of the image “B” that is the image information before being rewritten. As described above, even when the inversion processing is performed as part of the ghost reduction processing, image information on the inverted image is generated and the image display processing is performed.

The state of the inversion display processing here is shown by the e-book device 1 in the lower left part of FIG. 6. As shown in FIG. 6, when the inversion display processing is performed based on the image information (image information of the image “B”) stored in the sub-memory 6, an inverted image of the image “B” is displayed on the first display 2.

However, the image information used for the inversion display processing is related to the image “B” and does not match, in this state, the image information of the image “A” currently displayed on the first display 2, making it more likely for a ghost to occur.

Here, in the e-book device 1, the control circuit 7 and the first and second displays 2 and 3 are connected by a display signal line, and the control circuit 7 transmits the image information to the first and second displays 2 and 3. The display signal line is set in a disabled state during the execution of the ghost reduction processing.

More specifically, at the time when the ghost reduction processing is executed, the display signal line is maintained in the disabled state. Therefore, even when the image information on the image inverted by the inversion display processing is generated and displayed, the display signal line is in the disabled state; therefore, the image based on the image information is not actually displayed on the first display 2.

Therefore, the inverted image of the image “B” displayed on the first display 2 of the e-book device 1 in the lower left part of FIG. 6 is actually not displayed on the first display 2. Therefore, the presentation of the e-book device 1 in the lower left part of FIG. 6 is merely for helping to understand the contents of the above-described inversion display processing. Even in this state, the image “A” actually remains displayed on the first display 2.

Furthermore, the control circuit 7 controls the tone when the image is displayed in the ghost reduction processing so as to be lower than the tone of the image actually displayed on the display based on the image information. More specifically, although the image “A” is updated to the image “C” here on the first display 2, the control circuit 7 controls the tone of the image in the ghost reduction processing so as to be lower than the tone of the image “C” displayed on the first display 2 after the update processing. For example, when the tone of the image “C” displayed on the first display 2 after the update processing is 16, the tone of the image upon execution of the ghost reduction processing is 2, for example.

Therefore, for the inverted image of the image “B” displayed on the first display 2 of the e-book device 1 in the lower left part of FIG. 6, again, the display processing is performed with the tone lower than that of the image displayed on the first display 2 after the update processing.

Then, the control circuit 7 performs processing of rewriting the image information stored in the sub-memory 6 into the image information of the image displayed on the updated screen (the first display 2), and then displaying the image information (ST3).

As shown in FIG. 6, the image information of the image “B” is stored in the sub-memory 6 at the time when the image update processing and the ghost reduction processing are started. Therefore, the control circuit 7 acquires and rewrites the image displayed on the first display 2 from the main memory 5, that is, the image information of A. This state is shown in the e-book device 1 shown in the lower middle part of FIG. 6.

The reason why the image information stored in the sub-memory 6 is rewritten from the image information of the image “B” to the image information of the image “A” is as follows. Specifically, as described above, the condition for reducing a ghost is that the image information of the image displayed on the display matches the image information stored in the sub-memory 6. Therefore, it is difficult to reduce the occurrence of ghost even if the ghost reduction processing is performed in a state where the image information of the image displayed on the display is different from the image information stored in the sub-memory 6. Therefore, such rewrite processing is performed so that the image information stored in the sub-memory 6 matches the image information of the image displayed on the display.

Then, the control circuit 7 displays an image on the first display 2 based on the rewritten image information of the image displayed on the display. Here, because the image information stored in the sub-memory 6 is rewritten from the image information of the image “B” to the image information of the image “A”, the image “A” is displayed on the first display 2 based on the image information of the image “A”.

Then, the display of the image “A” here is also performed with the tone lower than that of the image “C” displayed on the first display 2 after the update processing. By suppressing the tone of the image display in the display processing during the ghost reduction processing, reduction in processing speed of the image update processing can be prevented as much as possible.

However, the control circuit 7 and the first display 2 are in the disabled state even when the rewriting and display processing is performed. Therefore, even when the image information in the sub-memory 6 is rewritten from the image information of the image “B” to the image information of the image “A” and the display processing is performed based on the image information of the image “A”, the image “A” based on this display processing is not displayed on the first display 2.

Therefore, the image “A” displayed on the first display 2 of the e-book device 1 in the lower middle part of FIG. 6 is not actually displayed on the first display 2. Therefore, the presentation of the e-book device 1 in the lower middle part of FIG. 6 is merely for helping to understand the contents of the above-described rewrite and display processing. Even in this state, the image “A” actually remains displayed on the first display 2.

Through the processing thus far, the image information stored in the sub-memory 6 is turned into the image information of the image “A” currently displayed on the first display 2, and the image displayed on the display matches the image information stored in the sub-memory 6. That is, the ghost reduction processing as described herein is thus completed. Therefore, upon execution of subsequent image update processing, an appropriate ghost reduction effect can be obtained by performing the image inversion processing in this state.

Then, processing of updating the image “A” and displaying the image “C” on the first display 2 is started. To this end, the control circuit 7 switches the display signal line connected to the display from the disabled state to the enabled state (ST4). As described above, the display signal line connecting the control circuit 7 and the display is normally kept in the disabled state, and is changed to the enabled state only when necessary.

The control circuit 7 performs inversion processing and display processing using the image information on the image “A” that is the image information before the image “A” currently displayed on the first display 2 is rewritten (ST5).

The e-book device 1 shown in the lower right part of FIG. 6 shows that the image on the first display 2 is inverted and displayed based on the image information of the image “A” that is the image information before being rewritten.

Here, the image displayed on the first display 2 is “A”, and the image information stored in the sub-memory 6 is also the image information on the image “A”. Therefore, by performing the inversion processing, it is possible to appropriately reduce a ghost that may occur when the image is updated from the image “A” to the image “C”.

The control circuit 7 further rewrites the image information stored in the sub-memory 6 from the image information of the image “A” to the image information of the image “C” in order to update the image displayed on the first display 2 from the image “A” to the image “C” (ST6). The e-book device 1 shown in the lower right part of FIG. 6 shows that the image information stored in the sub-memory 6 is rewritten from “A” to “C”.

Then, the display signal line already connected to the first display 2 is in the enabled state. Then, the control circuit 7 displays the image “C” on the first display 2 based on the image information of the image “C” rewritten and stored in the sub-memory 6 (ST7). This state is shown by the e-book device 1 in the upper right part of FIG. 6.

Note that the control circuit 7 switches a connection signal line connected to the first display 2 from the enabled state to the disabled state (ST8).

The processing of updating the presentation on the first display 2 from the image “A” to the image “C” is thus completed. Next, processing of updating the presentation on the second display 3 from the image “B” to the image “D” is performed.

In the explanatory diagram of FIG. 7, the e-book device 1 shown in the upper left represents the e-book device 1 at the start of the processing of updating the image “B” to the image “D” on the second display 3 and the ghost reduction processing. Also, the sub-memory 6 stores image information when the screen of the first display 2 is updated, that is, image information on the image “C”. This is indicated by the letter “C” displayed in the balloon in FIG. 7.

In this state, the image update processing and the ghost reduction processing on the second display 3 are started. First, the control circuit 7 performs the inversion display processing based on the image information before the image on the updated screen is rewritten, after the image update processing and the ghost reduction processing on the first display 2 are completed (ST9 in FIG. 5).

More specifically, the sub-memory 6 originally stores the image information of the image “C”. The control circuit 7 inverts the image on the second display 3 based on the image information of the image “C” that is the image information before being rewritten. The control circuit 7 also generates image information on the inverted image and performs image display processing.

Note that the illustration of the diagram shown in the lower left part of FIG. 6 is omitted in FIG. 7. However, on the second display 3, inversion display processing of the image on the second display 3 is performed as described above based on the image information of the image “C” that is the image information before being rewritten.

The ghost reduction processing is thus performed here based on the image information of the image “C”. Therefore, because the image information of the image “C” does not match the image information of the image “B” currently displayed on the second display 3, a ghost is likely to occur. However, as described above, because the display signal line is in the disabled state, the image based on the image information generated based on the display processing is not actually displayed on the display.

The control circuit 7 also controls the tone of the image “C” described above in the ghost reduction processing so as to be lower than that of the image “D” displayed on the second display 3 after the update processing. For example, if the tone of the image “D” displayed on the second display 3 after the update processing is 16, the tone of the image “C” in the inversion display processing is about 2.

By suppressing the tone of the image display in the display processing during the ghost reduction processing as described above, reduction in processing speed of the image update processing can be prevented as much as possible.

On the second display 3, the image “B” is updated to the image “D”. The control circuit 7 rewrites the image information stored in the sub-memory 6 into the image information of the image displayed on the updated screen (second display 3) and displays the image information (ST10).

As shown in FIG. 7, at the time when the image update processing and the ghost reduction processing on the second display 3 are started, the image information of the image “C” is stored in the sub-memory 6. Then, the control circuit 7 acquires and rewrites the image displayed on the second display 3 from the main memory 5, that is, the image information of “B”. This state is represented by the e-book device 1 shown in the lower left part of FIG. 7.

Then, the control circuit 7 causes the second display 3 to display an image based on the rewritten image information of the image displayed on the display. Here, because the image information stored in the sub-memory 6 is rewritten from the image information of the image “C” to the image information of the image “B”, the image “B” is displayed on the second display 3 based on the image information of the image “B”. As described above, the display of the image “B” here is also performed with the tone lower than that of the image “D” displayed on the second display 3 after the update processing.

However, the control circuit 7 and the second display 3 are in the disable state even during the rewriting and display processing. Therefore, even when the image information in the sub-memory 6 is rewritten from the image information of the image “C” to the image information of the image “B” and the display processing is performed based on the image information of the image “B”, the image “B” based on this display processing is not displayed on the second display 3.

Therefore, the image “B” displayed on the second display 3 of the e-book device 1 in the lower left part of FIG. 7 is not actually displayed on the second display 3. Therefore, the presentation of the e-book device 1 in the lower left part of FIG. 7 is merely for helping to understand the contents of the above-described rewrite and display processing. Even in this state, the image “B” actually remains displayed on the second display 3.

Through the processing thus far, the image information stored in the sub-memory 6 is turned into the image information of the image “B” currently displayed on the second display 3. That is, the image displayed on the display matches the image information stored in the sub-memory 6. The ghost reduction processing as described herein is thus completed. Therefore, upon execution of subsequent image update processing, an appropriate ghost reduction effect can be obtained by performing the image inversion processing in this state.

Then, processing of updating the image “B” and displaying the image “D” on the second display 3 is started. First, to this end, the control circuit 7 switches the display signal line connected to the display from the disabled state to the enabled state (ST11).

The control circuit 7 first performs inversion processing and display processing using the image information on the image “B” that is the image information before the image “B” currently displayed on the second display 3 is rewritten (ST12).

The control circuit 7 further rewrites the image information stored in the sub-memory 6 from the image information of the image “B” to the image information of the image “D” in order to update the image displayed on the second display 3 from the image “B” to the image “D” (ST13).

The e-book device 1 shown in the lower middle part of FIG. 7 shows that the image on the second display 3 is inverted and displayed based on the image information of the image “B” that is the image information before being rewritten, and that the image information stored in the sub-memory 6 is rewritten from “B” to “D”.

Here, the image displayed on the second display 3 is “B”, and the image information stored in the sub-memory 6 is also the image information on the image “B”. Therefore, by performing the inversion processing and the display processing, it is possible to appropriately reduce a ghost that may occur when the image is updated from the image “B” to the image “D”.

Then, the display signal line already connected to the second display 3 is in the enabled state. The control circuit 7 displays the image “D” on the second display 3 based on the image information of the image “D” rewritten and stored in the sub-memory 6 (ST14). This state is shown in the e-book device 1 in the upper right part of FIG. 7.

Once the processing is completed thus far, the control circuit 7 also switches the connection signal line connected to the display from the enabled state to the disabled state (ST15). As a result, the image on the second display 3 is updated from the image “B” to the image “D”.

However, a series of processing including the image update processing and the ghost reduction processing still continues. That is, although a series of processing may be completed in this state, it is required in this case to start over again all the steps described thus far when the next image update processing is started. Therefore, in order to shorten as much processing time as possible, the processing is carried on.

To be more specific, a series of processing is completed by performing the following processing. Specifically, after the update processing of the image on the second display 3 is completed, there is some time until the operator finishes reading the images displayed on the first and second displays 2 and 3 and issues an image update processing instruction again. In the meantime, the image update processing and the ghost reduction processing are temporarily held standby.

Then, when the update processing instruction is issued again, the update processing of the image on the first display 2 is started again. Note that, here, the execution of the update processing and the ghost reduction processing using the first display 2 as the updated screen does not change even if the page displayed on the display is turned forward or backward.

Therefore, the standby time is used to prepare for the image on the first display 2 to be updated quickly. The control circuit 7 first prepares for the first display 2 to be updated next.

Note that the image “C” is updated to another image on the first display 2. Here, the updated image differs depending on whether the operator turns the page forward or backward through the input unit 4. Either way, the update processing is executed.

First, the control circuit 7 performs the inversion display processing based on the image information before the image on the updated screen is rewritten (ST16). More specifically, because the image information of the image “D” is originally stored in the sub-memory 6, the control circuit 7 performs the inversion display processing of the image on the first display 2 based on the image information of the image “D” that is the image information before being rewritten.

Next, the control circuit 7 rewrites the image information stored in the sub-memory 6 into the image information of the image displayed on the updated screen (first display 2) and displays the image information (ST17).

Note that, upon execution of the ghost reduction processing including the inversion display processing and the rewrite and display processing, the reason why the display signal line for transmitting the image information to the display is kept in the disabled state is as described above. Likewise, the same goes for controlling the image tone in the display processing to be lower than that of the new image displayed on the first display 2 after the update processing.

As can be seen from the e-book device 1 in the upper right part of FIG. 7, the image information of the image “D” is stored in the sub-memory 6 when the image update processing and the ghost reduction processing are started again on the first display 2. Then, the control circuit 7 rewrites the image information into the image information of the image “C” displayed on the first display 2. This state is indicated by the e-book device 1 shown in the lower right part of FIG. 7.

Through the processing thus far, the image information stored in the sub-memory 6 is turned into the image information of the image “C” currently displayed on the first display 2. That is, the image displayed on the display matches the image information stored in the sub-memory 6. Therefore, an appropriate ghost reduction effect can be obtained by performing the image inversion process in this state. Therefore, the processing thus far is performed to complete the preparation.

By thus preparing for the next update processing using the time until the operator finishes reading the images displayed on the first and second displays 2 and 3 and issues an image update processing instruction again, the subsequent update processing can proceed quickly.

Then, the control circuit 7 checks if a signal for screen update is received from the operator (ST18). When no signal is received (NO in ST18), the control circuit 7 waits for a new signal to be received. On the other hand, when a new screen update signal is received from the operator (YES in ST18), the processing returns to step ST2 in FIG. 4 to start over the image update processing and the ghost reduction processing. Thus, a series of processing including the image update processing and the ghost reduction processing is completed.

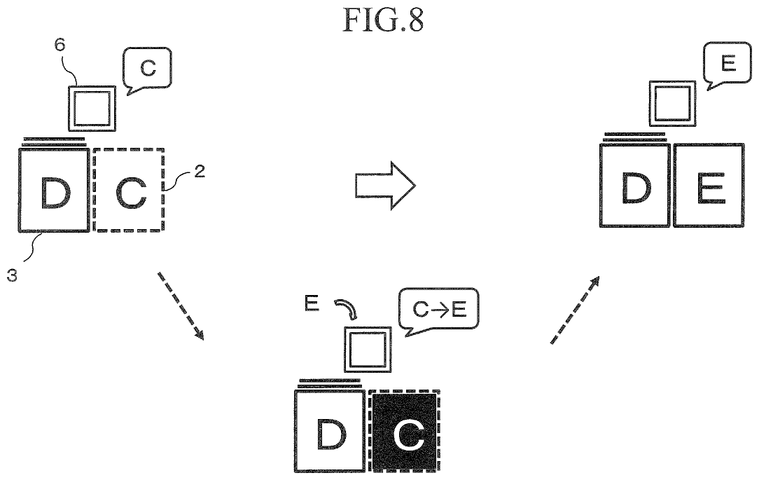

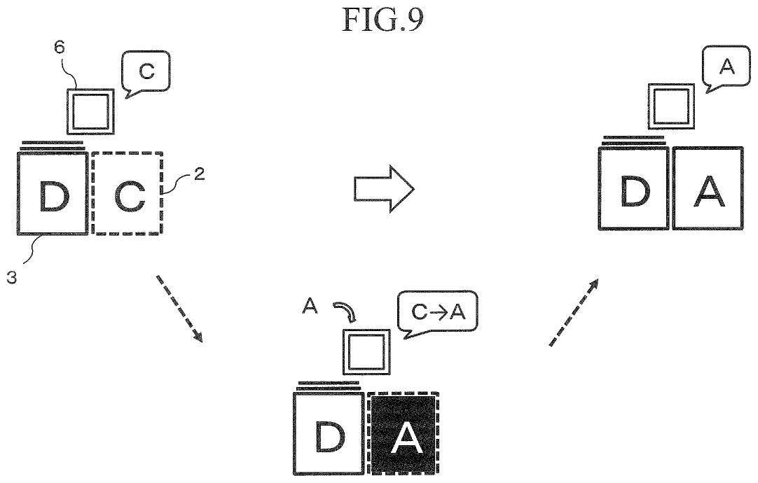

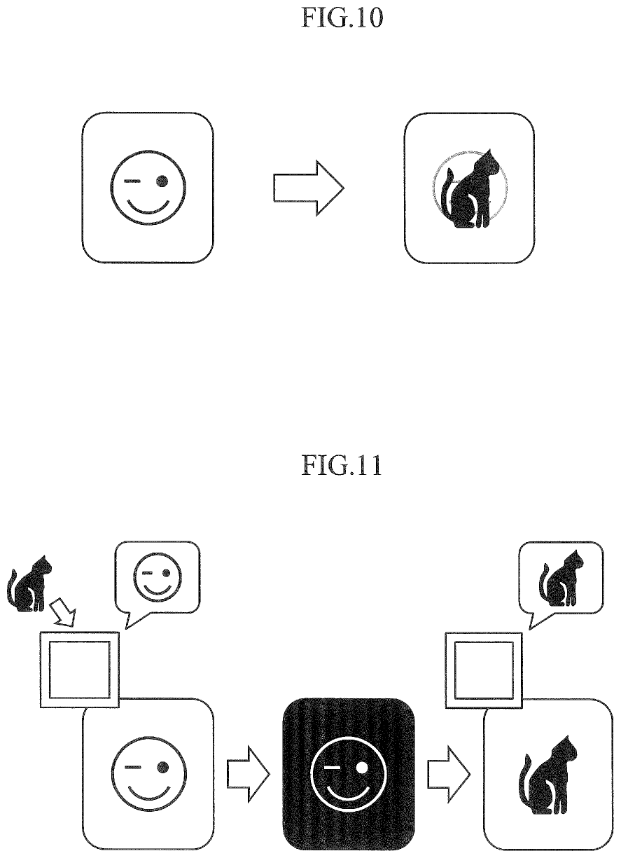

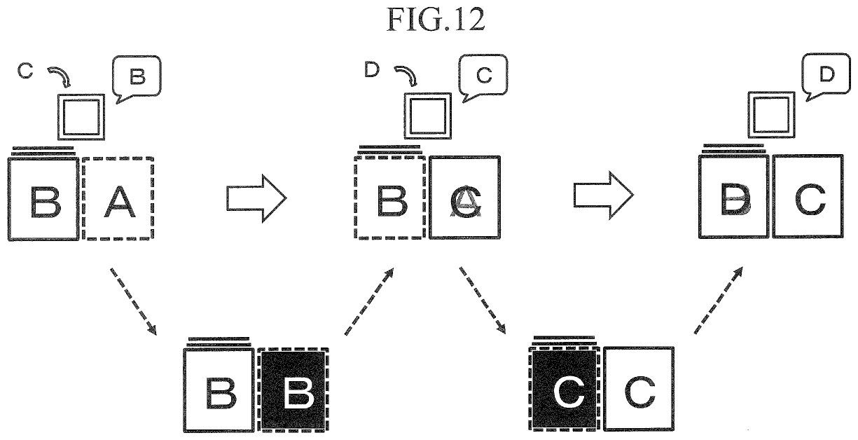

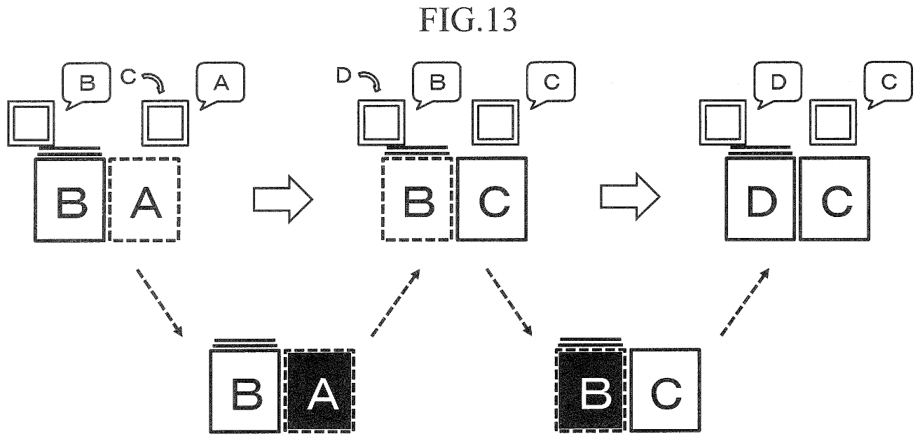

FIGS. 8 and 9 are explanatory diagrams each showing a flow of image update processing executed in the e-book device 1 according to the embodiment. To be more specific, FIG. 8 is an explanatory diagram showing a part of the image update processing in the case where the operator turns the page forward after the series of processing described above is completed. On the other hand, FIG. 9 is an explanatory diagram showing a part of the image update processing in the case where the operator turns the page backward after the series of processing described above is completed.

That is, FIG. 8 shows the e-book device 1 in a state where the operator operates the input unit 4 to turn the page forward. Therefore, when the page is turned forward, the image “C” currently displayed on the first display 2 is updated to an image “E” and the image “D” displayed on the second display 3 is updated to an image “F”.

FIG. 8 shows only the image update processing on the first display 2. As described above, first, the image information stored in the sub-memory 6 is updated from the image information on the image “C” to the image information on the image “E”. Then, the image inversion processing and display processing of the image “E” are performed based on the image information on the image “C”.

As described above, when the page is turned forward by the operator, the image information stored in the sub-memory 6 is already rewritten from the image information on the image “D” to the image information on the image “C”. Therefore, the ghost reduction processing can be quickly performed based on the image information on the image “C”.

On the other hand, FIG. 9 shows the e-book device 1 in a state where the operator operates the input unit 4 to turn the page backward. Therefore, when the page is turned backward, the image “C” currently displayed on the first display 2 is updated to the image “A” and the image “D” displayed on the second display 3 is updated to the image “B”.

FIG. 9 shows only the update processing of the image on the first display 2. As described above, first, the image information stored in the sub-memory 6 is updated from the image information on the image “C” to the image information on the image “A”. Then, the image inversion processing and display processing of the image “A” are performed based on the image information on the image “C”.

Here, as described above, when the page is turned backward by the operator, the image information stored in the sub-memory 6 is already rewritten from the image information on the image “D” into the image information on the image “C”. Therefore, it is no longer required to perform the ghost reduction processing again based on the image information on the image “C”.

More specifically, with reference to the flowcharts shown in FIGS. 4 and 5 described above, the processing of steps ST16 and ST17 in FIG. 5 showing the flow of the preparation described above corresponds to the processing of steps ST2 and ST3 shown in FIG. 4. Therefore, when the operator turns the page forward or backward, the processing can proceed directly to the image update processing on the first display 2 (from ST4 on down in FIG. 4) by skipping the processing of steps ST2 and ST3 shown in FIG. 4. As a result, the overall processing can be speeded up.

Note that, in FIG. 9, the description is given on the same assumption as in the description thus far that the image update processing and the ghost reduction processing are performed in the order of the first display 2 and then the second display 3 also when the page is turned backward by the operator. However, when the page is turned backward, the image update processing and the ghost reduction processing may be performed in the order of the second display 3 and then the first display 2, rather than the order of the first display 2 and then the second display 3.

In this case, the preparation processing described in steps ST16 and ST17 in FIG. 5 cannot be used. That is, the preparation here is based on the premise that the first display 2 is subjected to the image update processing and the ghost reduction processing before the second display 3. Therefore, in the case where the image update processing and the ghost reduction processing are performed in the order of the second display 3 and then the first display 2 when the page is turned backward, the ghost reduction processing shown in steps ST2 and ST3 in FIG. 4 for the second display 3 is executed again even after the preparation processing of steps ST16 and ST17 is performed.

With the configuration and processing described above, an electronic display device and an electronic display method can be provided, which are capable of sufficiently reducing the occurrence of ghost even with the use of one control circuit and one memory circuit when performing image update processing on a plurality of displays.

Particularly, by performing the above-described ghost reduction processing, the occurrence of ghost can be reduced when images are actually displayed on the displays. Furthermore, in the ghost reduction processing itself, the operation speed can be maintained by performing the inversion processing and the display processing with the lowered tone.

Although the embodiments of the present invention have been described above, these embodiments are presented as examples and are not intended to limit the scope of the invention. These embodiments can be implemented in various other forms, and various omissions, replacements, and changes can be made without departing from the invention. These embodiments and modifications thereof are included in the invention described in the claims and equivalents thereof, as well as included in the scope of the invention.

A list of reference signs used in the drawings follows.
1 e-book device
2 first display
3 second display
4 input unit
5 main memory
6 sub-memory
7 control circuit

1. An electronic display device comprising:
a plurality of displays that display content;
a sub-memory that temporarily stores image information of images to be displayed on the displays; and
a control circuit that controls presentation on the displays, wherein
upon updating the images to be displayed on the displays, the control circuit rewrites in advance the image information stored in the sub-memory into the image information of the image currently displayed on the display to be updated.

2. The electronic display device according to claim 1, wherein
in a state where a display signal line connected to the display to transmit the image information to the display is maintained in a disabled state, the control circuit inverts an image based on the image information stored in the sub-memory, rewrites the image information stored in the sub-memory into the image information of the image currently displayed on the display to be updated, and displays the rewritten image information of the image currently displayed on the display to be update.

3. The electronic display device according to claim 2, wherein
the control circuit controls the tone of the image during the processing of inverting and the processing of rewriting the image information stored in the sub-memory into the image information of the image currently displayed on the display to be updated and displaying the rewritten image information of the image currently displayed on the display to be update, so that the tone of the image is lower than that of the image displayed on the display based on the image information.

4. The electronic display device according to claim 1, wherein
after rewriting the image information stored in the sub-memory into the image information of the image currently displayed on the display to be updated and displaying the rewritten image information of the image currently displayed on the display to be updated, the control circuit further rewrites the rewritten image information into image information to be displayed on the display after the update processing.

5. The electronic display device according to claim 2, wherein
after rewriting the image information stored in the sub-memory into the image information of the image currently displayed on the display to be updated and displaying the rewritten image information of the image currently displayed on the display to be updated, the control circuit further rewrites the rewritten image information into image information to be displayed on the display after the update processing.

6. The electronic display device according to claim 3, wherein
after rewriting the image information stored in the sub-memory into the image information of the image currently displayed on the display to be updated and displaying the rewritten image information of the image currently displayed on the display to be updated, the control circuit further rewrites the rewritten image information into image information to be displayed on the display after the update processing.

7. The electronic display device according to claim 4, wherein
the control circuit switches a display signal line connected to the display to transmit the image information to the display from a disabled state to an enabled state when the image is displayed on the display based on the image information stored in the sub-memory and displayed on the display after the update processing.

8. The electronic display device according to claim 5, wherein
the control circuit switches a display signal line connected to the display to transmit the image information to the display from a disabled state to an enabled state when the image is displayed on the display based on the image information stored in the sub-memory and displayed on the display after the update processing.

9. The electronic display device according to claim 6, wherein
the control circuit switches a display signal line connected to the display to transmit the image information to the display from a disabled state to an enabled state when the image is displayed on the display based on the image information stored in the sub-memory and displayed on the display after the update processing.

10. The electronic display device according to claim 1, wherein
the display includes a first display and a second display on left and right surfaces, respectively, when the electronic display device is in a spread state.

11. The electronic display device according to claim 10, wherein
both of the first and second displays are controlled by one control circuit.

12. An electronic display method comprising, upon updating an image displayed on a display included in an electronic display device:
inverting the image based on image information stored in a sub-memory;
rewriting the image information stored in the sub-memory into image information of an image currently displayed on the display to be updated, and storing, in the sub-memory, and displaying the rewritten image information of the image currently displayed on the display to be updated;
further rewriting the rewritten image information of the image currently displayed on the display to be updated into image information of an image to be displayed on the display after updating; and
updating the presentation on the display with a new image based on the image information of the image displayed on the display after the updating.

13. The electronic display method according to claim 12, wherein
a control circuit includes switching a display signal line connected to the display to transmit the image information to the display from a disabled state to an enabled state between storing, in the sub-memory, and displaying the rewritten image information of the image currently displayed on the display to be updated and further rewriting the rewritten image information of the image currently displayed on the display to be updated into image information of an image to be displayed on the display after updating.
